(19) United States
(12) Patent Application Publication
(10) Pub. No.: US 2007/0266141 A1
(43) Pub. Date: Nov. 15, 2007

(54) Processing taxonomic extensions on the world wide web to implement an integrity-rich intelligence apparatus

(76) Inventor: Michael Anthony Norton, South Euclid, OH (US)

Correspondence Address: Michael A. Norton, 3771 Bridgeview Drive, South Euclid, OH, 44121, US

(21) Appl. No.: 11/333,642

(22) Filed: Jan. 17, 2006

Related U.S. Application Data
(60) Provisional application No. 60/672,697, filed on Apr. 19, 2005.

(51) Int. Cl. G06F 15/173

(52) U.S. Cl. 709/224

(57) ABSTRACT

Methods for implementing an Internet Operating System are described at the core as a Unified-Dynamic Domain Name Server (UD-DNS) system and may be referred to as a web integrity service (WIS). A list of root http addresses resides in a database. The top level domain (TLD) is parsed from the list. New TLD extensions representing human-based networks of integrity-founded information are bound to the previously parsed second-level domain names and assigned a Registry Identifier Number (RIN). The list is transferred to an authentication registry server. For each new http address/RIN, a dataset component template is imported and encrypted into a global encryption key. A bindery service connects the end-user of the Internet to a validation service through which a dataset component template may be populated and, per each new TLD's entity domain and qualification servers, displayed. Methods for conveying populated information comprise a software program of graphical user interface (GUI) systems with USML-(United States Markup Language)-encrypted stylesheets which are browsed via methods described herein. An Internet Configuration Panel (ICP) comprises the GUI system that connects a user with the UD-DNS system.

### BACKGROUND OF THE INVENTION

The paradox of creative logic is that we aspire to make what remains forever reliant upon the order of things. The problem from which the necessity of this invention derives is inherent in that minimal precedence has been placed upon, if any at all, the Internet, herein referred to as the prior art for general purposes, with regard to the convergence among extensible markup technologies and the top level domain name server system. Such an idea, if prior art does exist, has not been coordinated due to an overwhelming adherence between major Internet stakeholders and primary Internet writers:
“Most of the organizations that were signing up [with the World Wide Web Consortium] were companies interested primarily in advancing the technology for their own benefit.” (Berners-Lee, Weaving the Web, 2000)

Precedence has yet to be placed upon parallel management strategy within the top level domain (TLD) organizations of the Internet, although in 2005 ICANN (the Internet Corporation for Assigning Names & Numbers) did in fact indirectly promote the measure. A core value of ICANN is “To the extent feasible and appropriate, delegating coordinating functions to, or recognizing the policy role of, other responsible entities that reflect the interest of affected parties”:
“This core value too favours sponsored top level domains where the policy role is delegated.” (Sun, Yan, Domain Expansion white paper presentation, Jul. 11, 2005)

However, another core value of ICANN is “Respecting . . . by limiting ICANN's activities to those matters within ICANN's mission requiring or significantly benefiting from global coordination.” To date, no such precedence has been asserted upon ICANN with regard to distinguishing information technology via the prior art specific to non-international communities (eg: the United States) other than flatly portioning the generic TLDs .gov and .mil to government and military sectors, respectively.

The delineations between and subsequent asynchronous growth among the TLDs .gov, .com, .edu, and org have marginalized resource-specific goals among each of those TLD knowledge communities, whereas .net, info, and .biz have further generalized the broad commercial imbalance among the prior art, leaving non-commercial business conventionally belonging to the .gov, .edu, and org stakeholder—such as security, research, and development—to the semantic wayside. Much of this may be attributed to the asynchronous development between writing standards and writing policy—or rule-making—thereby setting precedence upon the former (Berners-Lee, Weaving the Web) among the prior art.

Even while commerce may be an effective motivator for each of these separate enterprises (government, education, philanthropy), the velocity by which information proliferates around the world via the prior art has turned commerce in this context into a proverbial firewall against these enterprises' needs to develop the same technologies in due stride.

While e-commerce has been volatile, other entries into our society via the prior art have gone unnoticed:
assimilation of Communist and democratic ideologies,
formation of borderless anarchist groups,
totalitarian regimes without geo-spatial assignment,
terrorist conspiracist communications channels,
stigmas placed on libertarian/Constitutional values,
obfuscation of marketplace values,
obfuscation of energy maintenance,
obfuscation of environmental awareness,
obfuscation of both health risks and medicine,
obfuscation of commercial responsibility, and
obfuscation of government accountability.

The results are:
decreased security, privacy, and intellectual property rights protection,
an enormous shift away from institutional education toward a de-centralized, ad hoc, and sometimes even commerce-weighted course of learning,
an at-times counter-productive administration capacity between W3C and ICANN,
a gap between the aforementioned organizations and government organizations,
proliferation of social machines in violence-oriented processes,
a lessening of reliability on the prior art's Internet Protocol-DNS (Domain Name Server) systems, and
a double-edged brand of philanthropy that does not directly assume all the altruism of giving in support of growth, freedom, prosperity, and equality.

MIT admits to the problem of the convoluted architecture of the Internet (“The Internet is Broken”, Talbot, David; Technology Review, January, 2006), and with its respected team of Internet engineers, recognizes the pitfalls we have faced, are facing, and will continue to face should the Internet be left on course as it is today. Furthermore, the National Science Foundation plans to devote $230 million to research in the next several years to mitigate this problem.

The problem resides in the growth of the semantic web, in that as the function of the Top Level Domain associates itself within social, cyber-based networks, so directly does, for example, VeriSign with its .com and .net registry services, when, in fact, there are top level domains, semantically, that exist outside of the purview of the prior art. Both ICANN and VeriSign, however, have moved to resolve this issue by moving to end, in 2005, a years-long litigation battle of that largest top level domain (.com) of the prior art. The problem resides in not necessarily making the prior art more complex, although some engineers question the appropriateness of its current simple architecture as it continues to proliferate. The problem may not directly lie within the networks of the Internet either, but in a general lack of having an Internet Operating System to protect clients from its array of pitfalls. Currently, Operating Systems such as Microsoft's Windows are largely under attack via the shortcomings of both Internet architecture and the architecture of the PC as it has assimilated with the rapid growth of the Internet.

### SUMMARY OF THE INVENTION

While appending the Internet with a replacement through which users may have better interaction, quality, and content precision capabilities during their experience, Internet users will be provided a choice as to the direction in which they would like the prior art to evolve. Spam, phishing, viruses like worms, intrusions, and identity theft will be significantly reduced and even made obsolete by implementing a system in which the user sets precedence among Internet traffic being conducted by the client.

The user may not only navigate the net, but may draw the map for it with the invention. Governments may also detect, map, and prevent enemy systems from emerging from cyberspace with the invention. An Internet Operating System will benefit
the consumer with regard to privacy rights, learning, and confidence,
the researcher with extended regard to how the Internet has already made advances in this field,
the government with regard to information assurance, privacy and protection, terrorist and emergency preparedness, and government-wide accountability,
the Internet Service Provider, in that competition, innovation, and approaches to further Internet integrity will be provided,
the World Wide Web Consortium in that its goals will be furthered with an added degree of accountability and resourcefulness,
the Internet Corporation for Assigning Names & Numbers in that its devotion to public service may be extended in dynamic parallel with existing government systems, leveraging efficiencies of both.

The components of an Internet Operating System are derived from processing taxonomic extensions on the world wide web to implement an integrity-rich intelligence apparatus. These derivations generally comprise:
a new language (USML) to counter the hyper-prolific and unaccountable use of XML,
a Unified-Dynamic Domain Name Server System (UD-DNS),
several externally-managed top level domains such as law by the DOJ and .epa by the EPA,
an adherent proximity to current Internet architecture (as to not promote disruption of interconnected systems), such as that vastly comprised under the .com top level domain,
protocols for IP addressing,
UD-DNS-compliant hardware applications such as routers, hand-helds, and mobile phones,
several Graphical User Interface software components that, individually, offer the user calibration tools for the Internet, and, combined, offer the user a new portal through which to traverse the Internet, and
encrypted dataset templates specific to externally-managed TLDs as claimed herein.

### LIST OF FIGURES

This application file contains at least one drawing executed in color. Copies of this patent application publication with color drawings will be provided by the Office upon request and payment of the necessary fee. A fuller understanding of the nature and objects of the present invention will become apparent upon consideration of the following detailed description taken in connection with the accompanying drawings, wherein:

FIG. 1 is an Internet Configuration Panel (ICP) embodying the method of invention in Graphical User Interface (GUI) form, which may be offered as a service among current web browsers or stand-alone.

FIG. 1A is an Access Bar, a GUI component of the ICP (FIG. 1), which tells the web user which new TLDs have available information related to the website the user is browsing by color-coding; in this illustration, “green” tinted buttons describe new TLD websites applicable to the website the user is browsing, and “salmon” tinted buttons tell the user no such information is registered in relation to the site. Each unit is clickable and may re-direct the user to relavant websites.

FIG. 1B is a pair of Autonomous Systems Viewer (ASV) Bars, GUI components of the ICP (FIG. 1), which the user can monitor while browsing the Internet to check the overall integrity of surfed websites. The more “green-blue” on the spectrum, and subsequently less “red-yellow”, denotes more integrity-rich content. The difference between the readings of the two bars is scalar and set by the web user (eg: one bar may denote overall rankings of all combined rankings of new TLDs, one bar may adjust those rankings according to User's Precedence Tuners (FIG. 1G), and one may additionally provide aggregated data per user's choice, such as a viewing of the compilation of data over a set period of website traversals). For an ICP Expert version of the component, there may be a Mode-Select Switch that will toggle between the described use of these bars to an “RF-Spec Mode”, wherein the first ASV bar will display a legend of available RF spectrum, whereas the second ASV bar will display used portions of the spectrum, as applicable to the web space the user is browsing, with clickable attributes accessible from each of the 10-unit sections of the bar, divided by the white descriptor bars (FIG. 1B).

FIG. 1C is a Web Precision Dial, a GUI component of the ICP (FIG. 1), which the user can switch to a specific new TLD in order to view unique overlays (FIG. 3) or to surf the Internet with websites that only have content on the Web Precision Dial-specified new TLD. User may also use the Dial to limit website traversal to sites specifically residing on the new TLD alone. In these illustrations, “.epa” and “.law” may be replaced with “Environment” and “Law” for semantic purposes.

FIG. 1D is a Utopia Tuner Display, a GUI component of the ICP (FIG. 1), where settings from the new TLD's on the PMR Display (FIG. 1E) and the user's interests are assimilated and viewable, once the Precedence Tuner (FIG. 1G) is set. In the EPA units denoted with “X” here, the symbol may be replaced with clickable icons in the future, linked to datasets more specific than those listed in FIG. 4A describing the relevant data.

FIG. 1E is a Parallel Management Rank (PMR) Display, a GUI component of the ICP (FIG. 1), which identifies by color, and percentile degree, for the user where the browsed website stands with regard to the new TLD's relevant information. Each unit may contain icons to further specify data and may be linked to datasets or instructions for visual overlays and image maps residing on the new TLD. In this example, the asterisk (*) label on each of the first compliant (green) bars denotes that the website is registered with the corresponding agency. Any of the salmon-colored units may also be clicked on to reveal datasets of questionable (“?”) merit from the perspective of the agency. Clicking on the “%”-labeled icons will further specify the website's standing with that agency (new TLD).

FIG. 1F is a Restrictions Menu, a GUI component of the ICP (FIG. 1), wherein the user may select with which new TLDs (both “generic” and “agency” views are shown, left-to-right, respectively) will require websites to be registered, thereby limiting the number of websites the user may possibly traverse to those relevant by the user's choice. In this illustration, only websites registered with the SEC, DOJ, and the FCC, including their new Adult Content TLD (.prn), will be included in the user's Internet experience.

FIG. 1G is a Precedence Tuner, a GUI component of the ICP (FIG. 1), wherein by toggling the “Drag” icons within each bar, the user pre-conditions the browser experience to be alerted according to personal interest relevant to specific agencies. Here, interest per agency is adjusted on a scale of 1-10. This tuner will effect how the Autonomous Systems Viewer Bars (FIG. 1B) are viewed as well as the Utopia Tuner Display (FIG. 1D).

FIG. 2 illustrates the core UD-DNS server relationships between the client (the web user), the Internet Service Providers, and the Web Integrity Service, and may be more fully understood while reviewing the Description of the Preferred Embodiment of the invention.

FIG. 3 illustrates how visual overlays of enumerated information systems may appear along the Ohio-Pennsylvania border, specific to the website a user is browsing and relevant by the user's ICP settings (FIG. 1). Flagpoints (FIG. 3A) indicate warnings which have geo-spatial relevance (FIG. 3C) according to user precedence (FIG. 4). In this illustration, the vicinity of the website owner is displayed (FIG. 3B) wherein green- and salmon-tinted overlays (FIG. 3C) alert the user to trends emanating from the calibrated data, some of which may point to a website host or other affiliate, or “reciprocal state” (FIGS. 6A-B, 7C, 7E), in the Pittsburgh area; overlays may be calibrated by switching the Web Precision Dial (FIG. 1C), for example, and viewed by simply clicking an “Overlay” button on a Tools or Options menu. [Background photo ©2005 Google, Inc.]

FIGS. 4A-J illustrate how re-directs may display new TLD-specific information when, for example, the user clicks on an icon within the Access Bar (FIG. 1A) on the bottom of the ICP (FIG. 1), comprising:

FIG. 4A illustrates how information may be displayed and accessed when directed to an “.epa” top level domain.

FIG. 4B illustrates how information may be displayed and accessed when directed to an “.law” top level domain.

FIG. 4C illustrates how information may be displayed and accessed when directed to an “.fcc” top level domain.

FIG. 4D illustrates how information may be displayed and accessed when directed to an “.ftc” top level domain.

FIG. 4E illustrates how information may be displayed and accessed when directed to an “.sec” top level domain.

FIG. 4F illustrates how information may be displayed and accessed when directed to an “.hhs” top level domain.

FIG. 4G illustrates how information may be displayed and accessed when directed to an “.prn” top level domain.

FIG. 4H illustrates how information may be displayed and accessed when directed to an “.med” top level domain.

FIG. 4i illustrates how information may be displayed and accessed when directed to an “.doe” top level domain.

FIG. 4J illustrates how information may be displayed and accessed when directed to an “.dos” top level domain.

FIGS. 5A-9B illustrate general information regarding the prior art, and the process of improving the architecture of the art:

FIG. 5A illustrates background information regarding the art, wherein a Medium represents a transmission of information between a stimulus node and a recipient node, the latter of which becomes a response node once the transmission is received.

FIG. 5B illustrates background information regarding the art, wherein the Internet is the Medium, delineated into three domains (physical, cognitive, and cyber) with the flow of information from users (consumers) to operators (providers) on each endpoint of the Medium.

FIG. 5C illustrates background information regarding the art, wherein the Internet is further delineated to illustrate that the consumer has control of the Medium as far as the physical and cognitive domains reach, but loses control once it is transmitted via the cyber domain.

FIG. 5D illustrates background information regarding the art, wherein a one-way flow of information (among corporations) within the cyber domain of the Internet causes identity theft, fraud, and an overall lack of security.

FIG. 5E illustrates background information regarding the art, wherein consumers are effected by this discrepancy, an example being the marketing and selling of user information among corporations without the consumer knowing it.

FIG. 6A illustrates how the consumer exists outside of the prior art's architecture, wherein commercial and government entities share a state of reciprocity—a commonplace for transformation—via a unique Top Level Domain for each.

FIG. 6B illustrates an improvement to the problematic architecture of the prior art: provide the consumer with the intersecting transformational state between business and government.

FIG. 7A illustrates structure in a response node, wherein the line extending upward and left represents time-of-process, wherein the line extending downward and left represents prior-response, and wherein the plane between both lines which extend right represents an array of possible next-responses. In this example, the response node is “Grove USA”, its array of possible next-responses essentially comprised of several additional response nodes, as illustrated.

FIG. 7B illustrates a response node, wherein the node is the World Wide Web Consortium (W3C), whose members are essentially comprised of over 300 response nodes, most of which are high tech Internet companies, as illustrated.

FIG. 7C illustrates two response nodes: the W3C and ICANN (the Internet Corporation for Assigning Names & Numbers), with the URI (Universal Resource Identifier) node situated among these two entities; specifically, the URI node remains in their reciprocal state (where transformations occur).

FIG. 7D illustrates the background information of the art: the result is a “security complex” with billions of dollars being spent on patching infrastructure problems.

FIG. 7E illustrates the beginning of a resolution: Grove USA may position itself within a reciprocal state between ICANN & W3C; thereby allowing suitable URI node (taxonomic extension) transformation.

FIG. 8 illustrates the consumer's position wherein processing taxonomic extensions among the reciprocal state shared by both Grove USA and ICANN & W3C may transpire: the “.com” URI suffix (or, TLD) tips the balance of information within a democratic state. For example, websites are used primarily like business cards and brochures for marketing and selling purposes.

FIG. 9A illustrates (for example, demonstrating with Microsoft Corporation's website address) further how this transformation can improve the shared architecture of the Internet.

FIG. 9B illustrates (for example, demonstrating with Microsoft Corporation's website address) further how this transformation can improve shared architecture of the Internet: wherein a new TLD, law, is operated by the Department of Justice and afforded accordingly to the Internet user, whose ability to configure the web may add integrity to the prior art as well as that of the invention.

### DESCRIPTION OF THE PREFERRED EMBODIMENT

In 1998, the U.S. Department of Commerce decided to set up a private company to serve as the primary policy-maker with regard to domain naming and assignment conventions for the Internet. That company is the Internet Corporation for Assigning Names & Numbers (ICANN), and is heavily burdened with international policy. Around the same time, the extensible markup language (XML) and many of its subset languages—such as MathML—were in process for candidate recommendation status by the World Wide Web Consortium. That is, XML and its subsets were being drafted and then, through consensus-based methods, set as standard web languages through which any Internet user could utilize in building a domain space on the Internet.

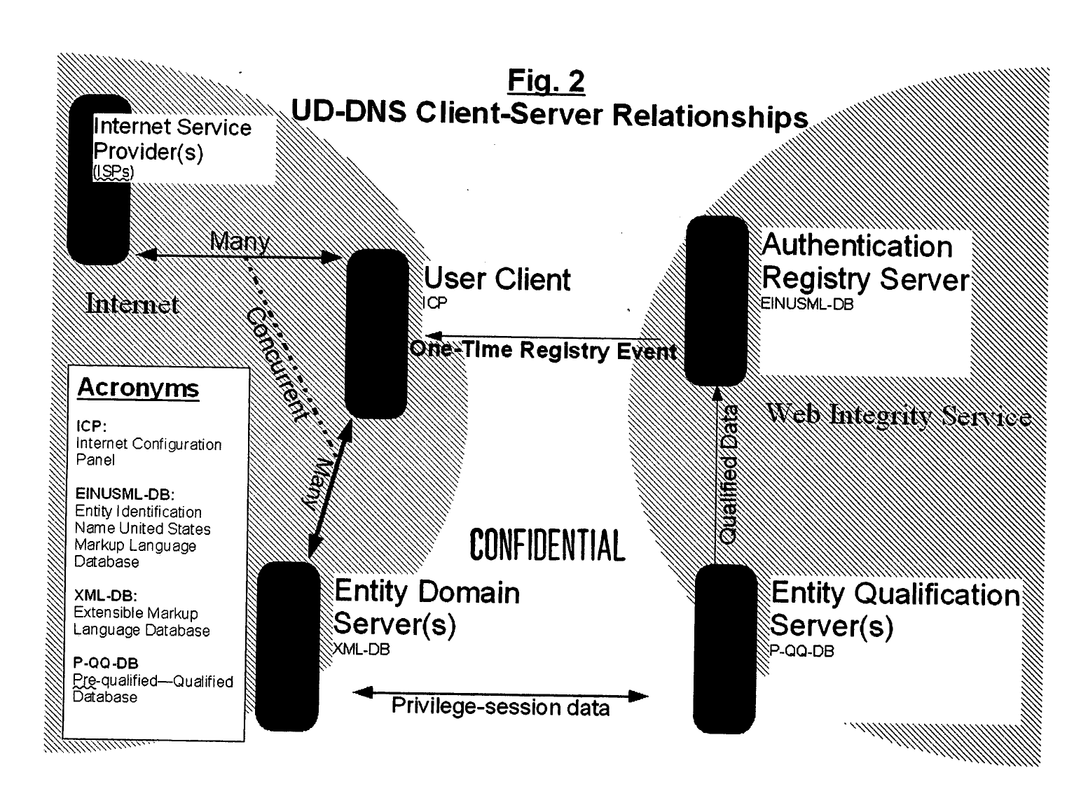

As the Department of Commerce (DoC) is still closely in a working relationship with ICANN, the invention may be implemented by obtaining, through DoC, for the purposes of building the Entity Identification Name United States Markup Language Database (EINUSML-DB) (FIG. 2), a list of all ICANN-registered website addresses and host server IP addresses. This is the preferred method through which the invention may begin to be implemented, although methods are not limited to this and may be alternatively processed at a much more incremental pace.

Once a full list is obtained or constructed, and residing on a server to be identified as the Authentication Registry Server (ARS, FIG. 2), the list may be sorted by TLD designation, then parsed into representative http addresses for each external management agency or organization, such as the Department of Justice and the Environmental Protection Agency. Using these two examples, three lists of http addresses exist, all of which have an EIN attached to them:
(1) List 1—www.httpAddress.com
(2) List 2—www.httpAddress.doj
(3) List 3—www.httpAddress.epa

While List 1 would reside on the ARS within the EINUSML-DB, List 2 may be delivered to the Department of Justice, and List 3 to the EPA.

The DoJ and EPA may then establish their Entity Qualification Server (EQS), where their respective list of http addresses may reside. They then, in coordination with a Federal XML Working Group (XML-WG), and with an Intelligence Community Metadata Working Group (ICM-WG), may sort their XML prior art data into subsets of their EIN-established addresses. Example:
(1) EIN: plumb technologies, inc. [CompanyName]
(2) EQS Name: DoJ—.law [EQSname.EQStld]
(3) Pre-qualified elements:
(4) Patent File #60/672,697 [CaseloadFileDescription]
(5) EIN: plumb technologies, inc. [CompanyName]
(6) EQS Name: EPA—.epa [EQSname.EQStld]
(7) Pre-qualified elements: Smoking in Office—$1 million [FineDescription.FineAmount]

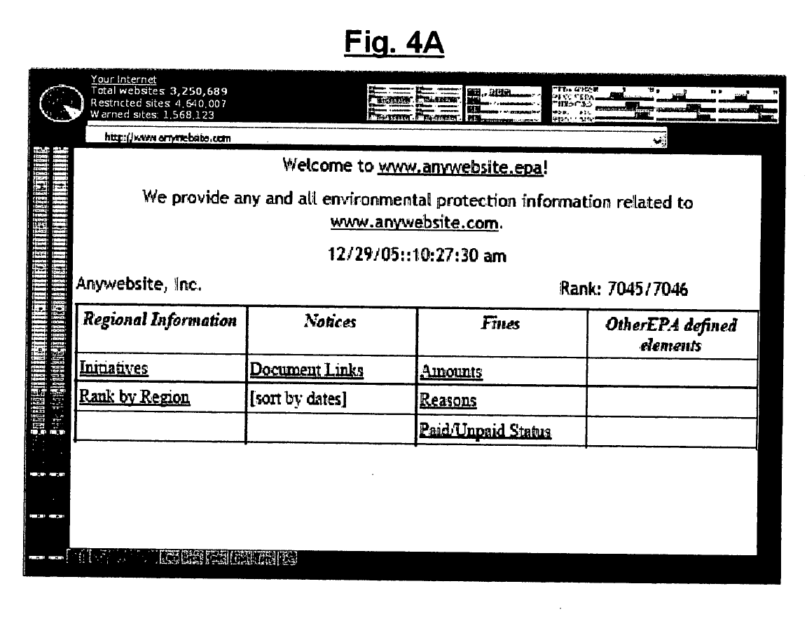

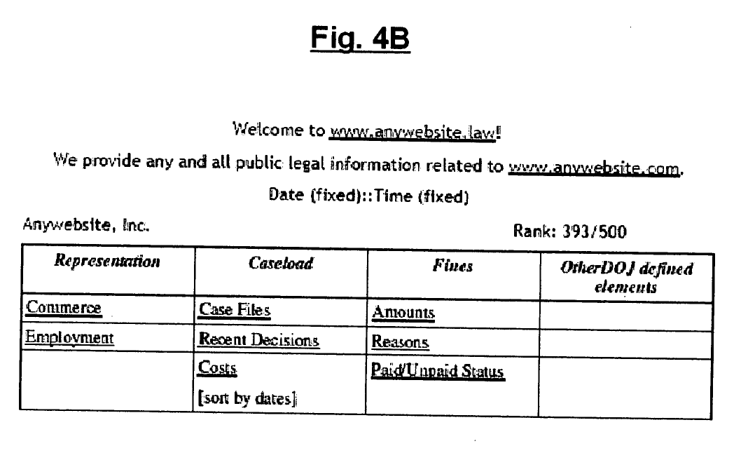

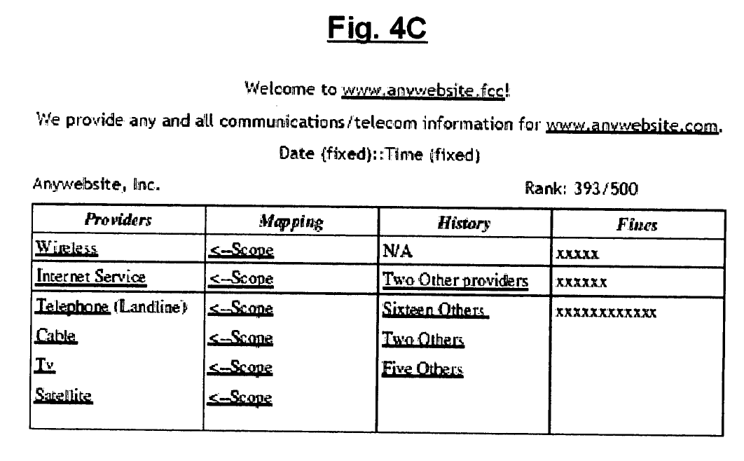

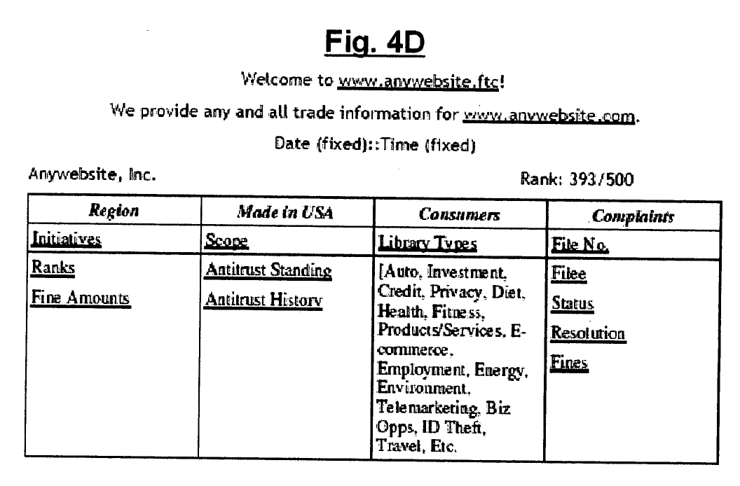

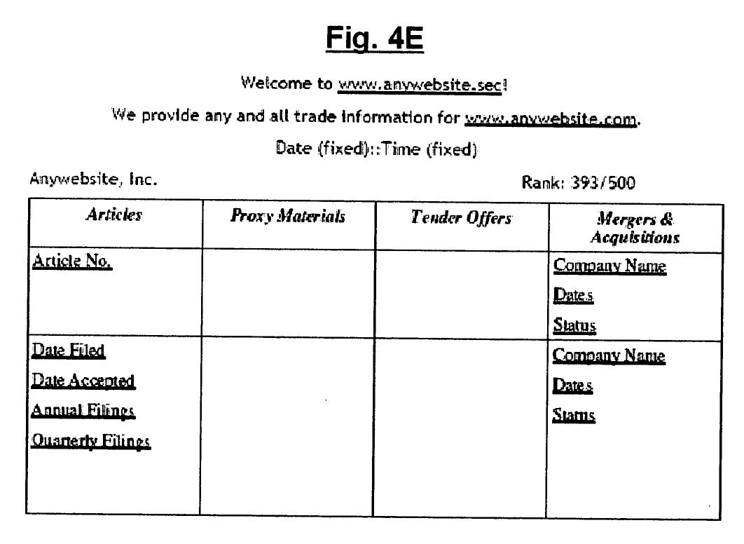

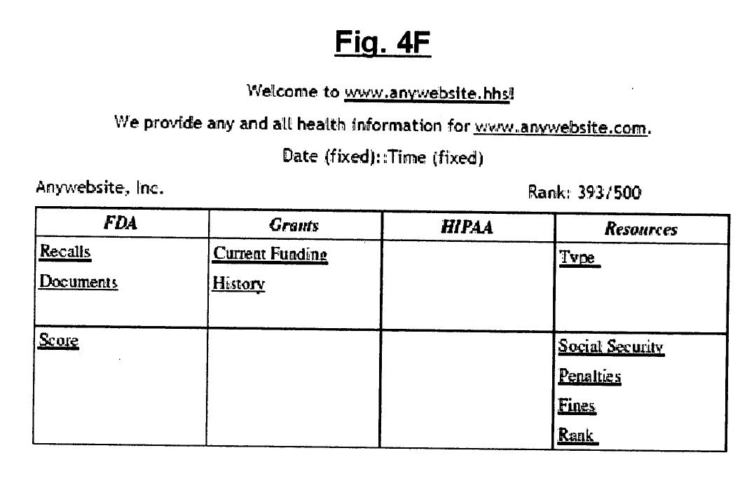

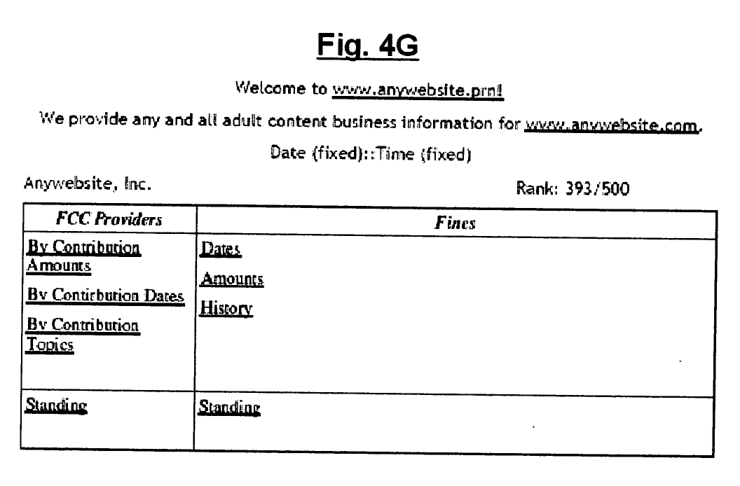

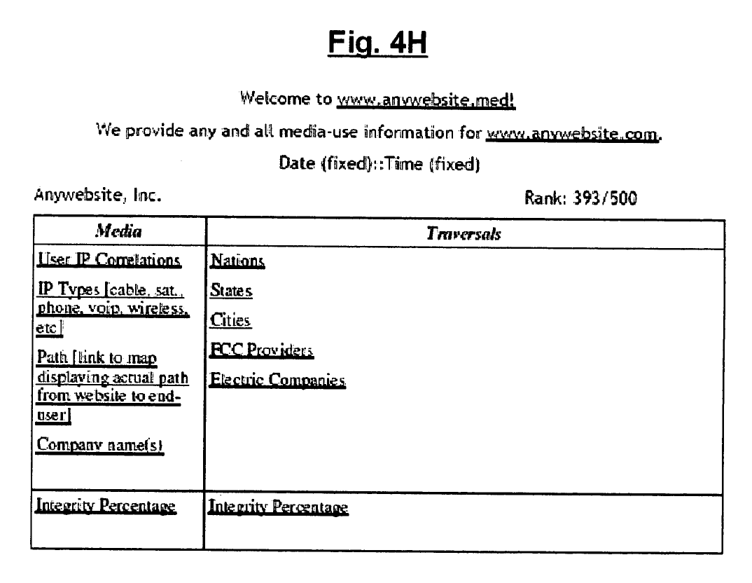

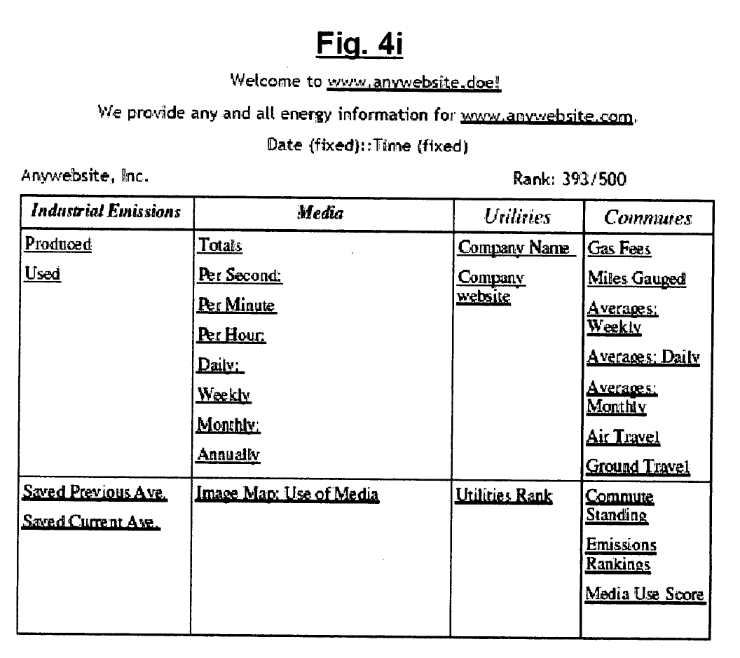

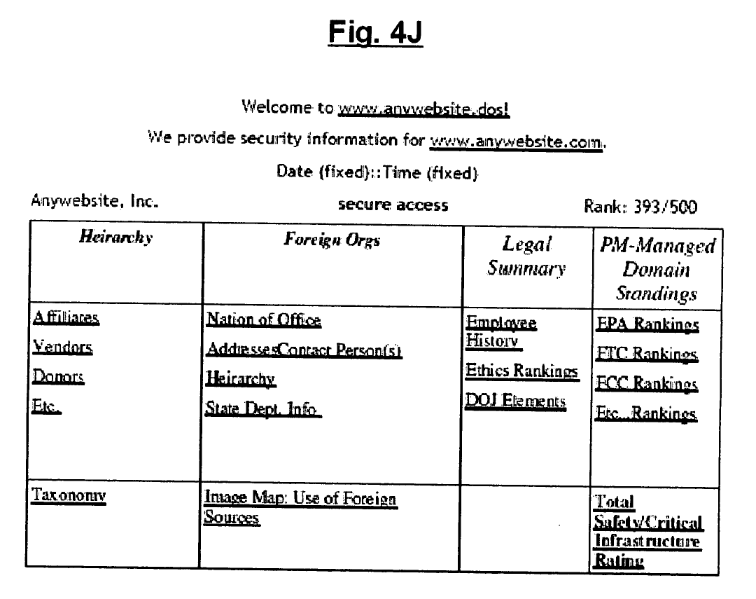

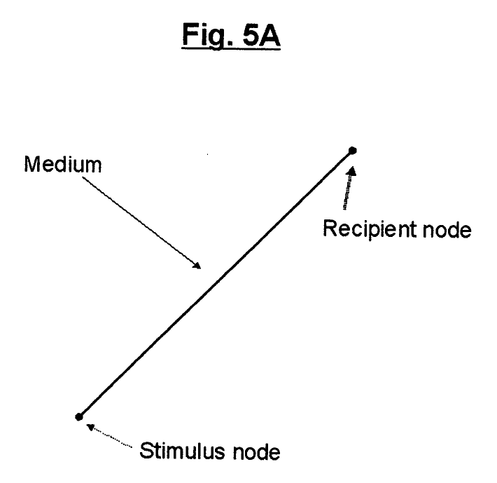

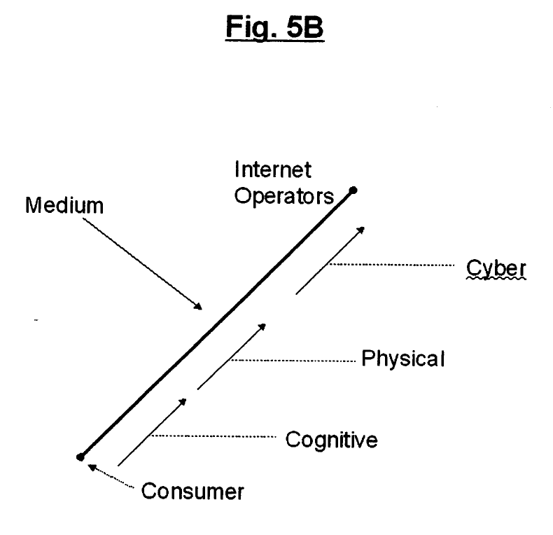

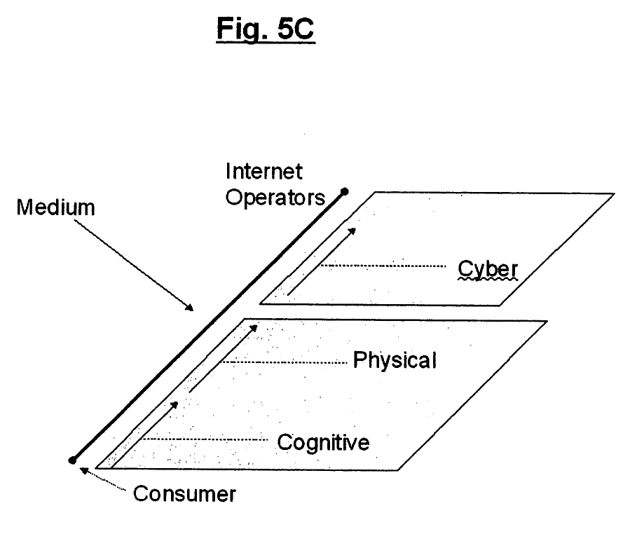

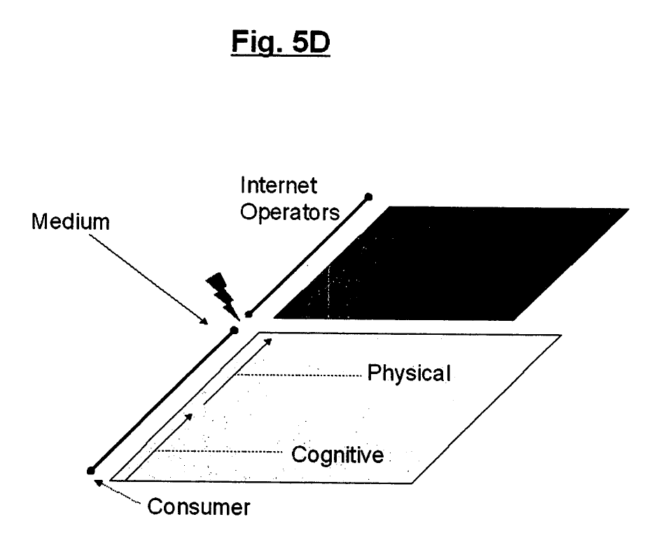

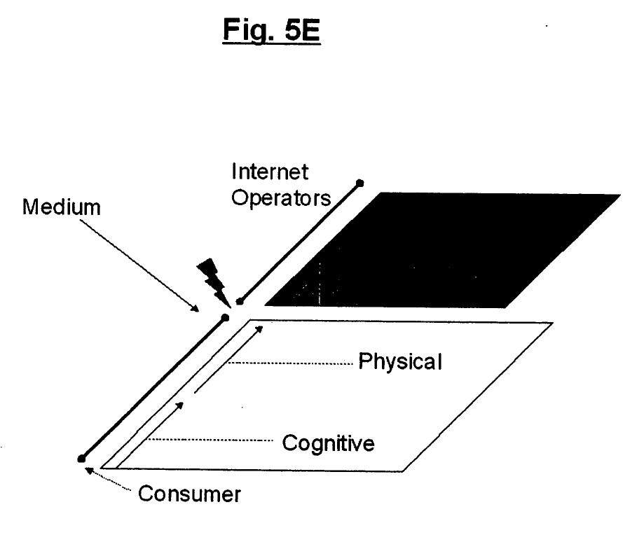

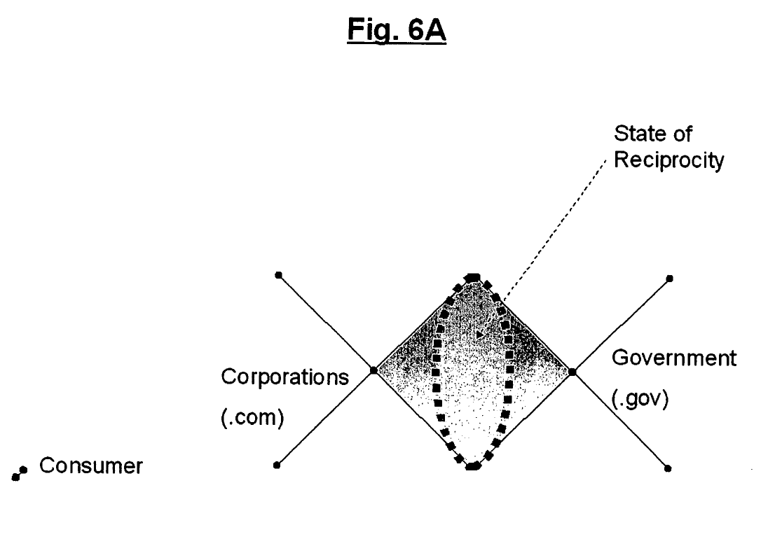

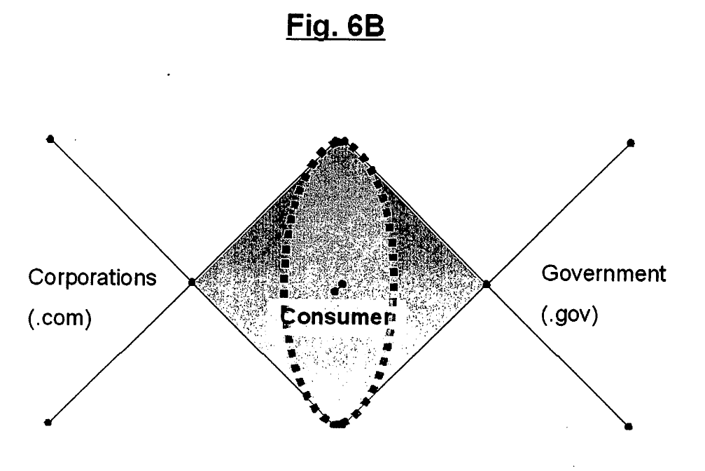

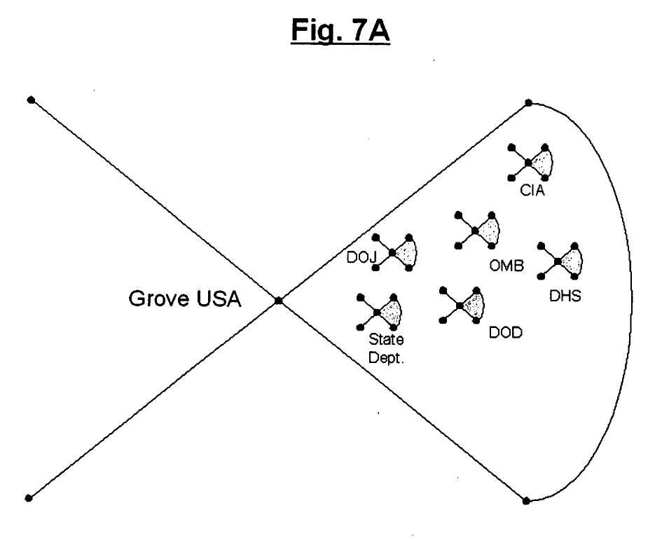

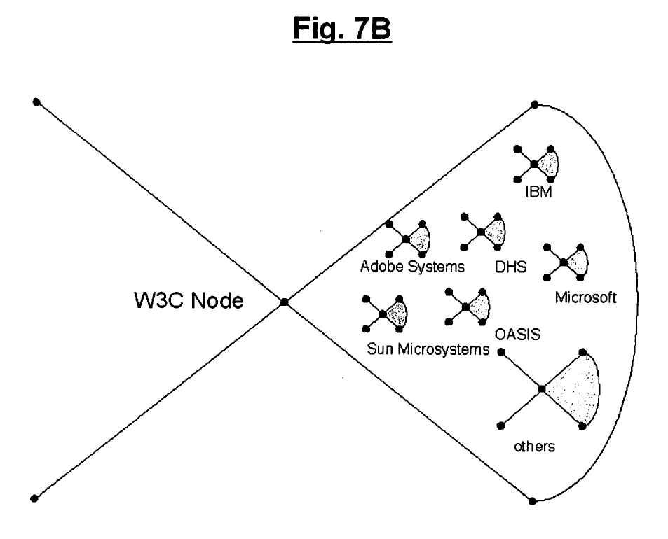

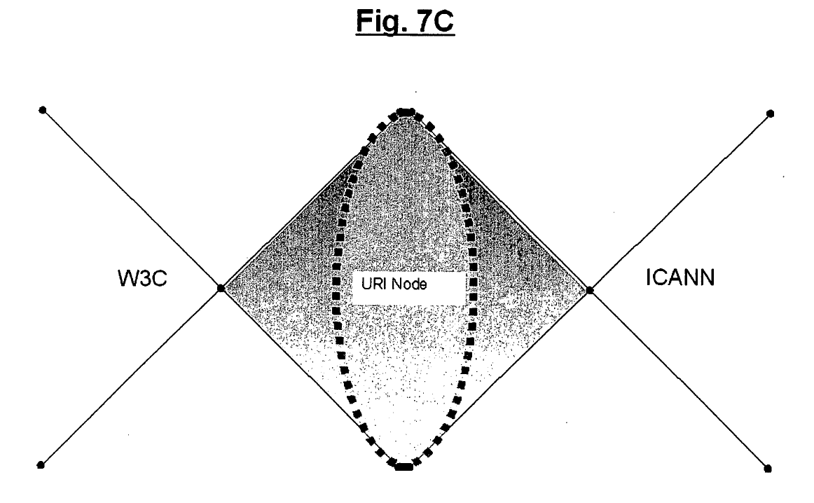

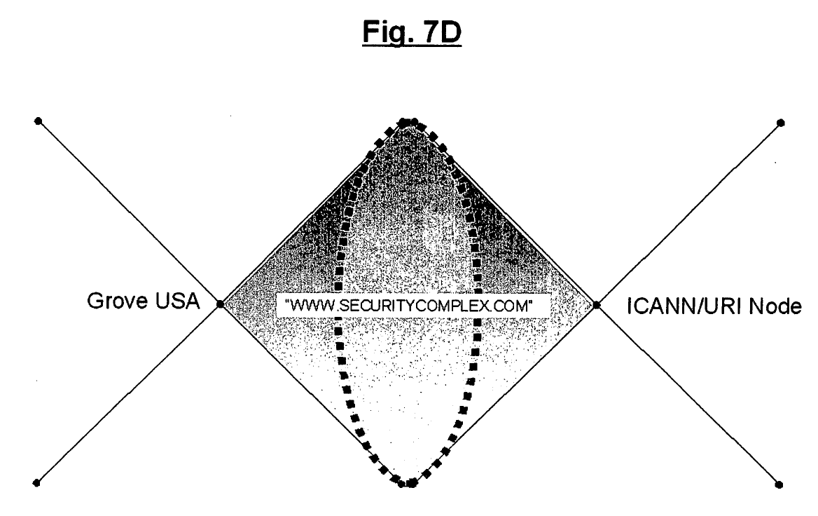

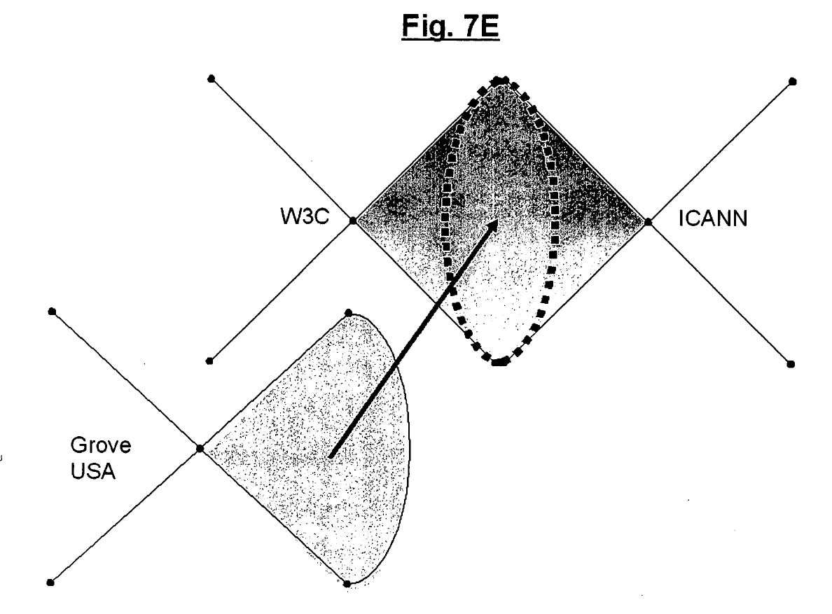

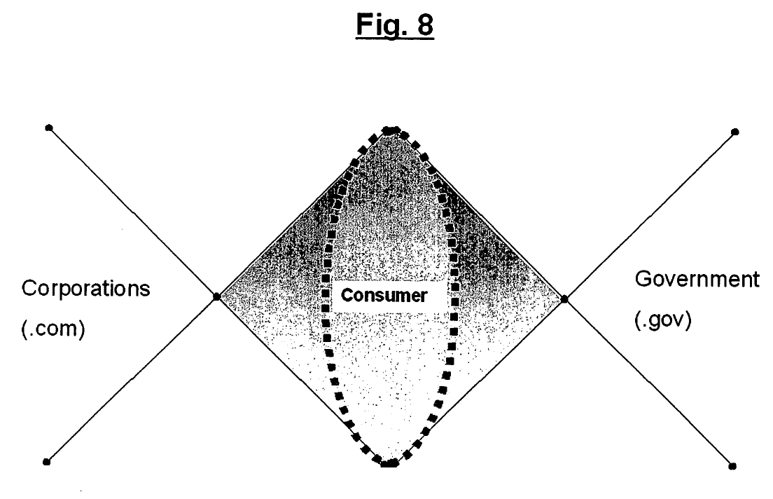

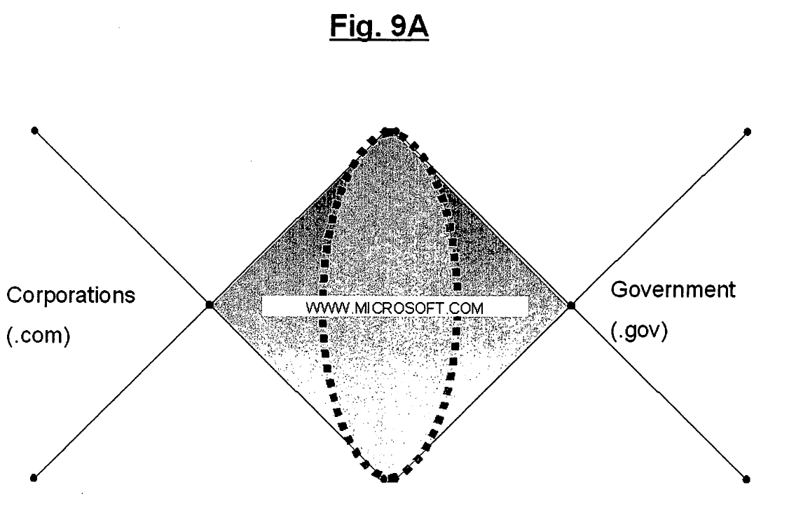

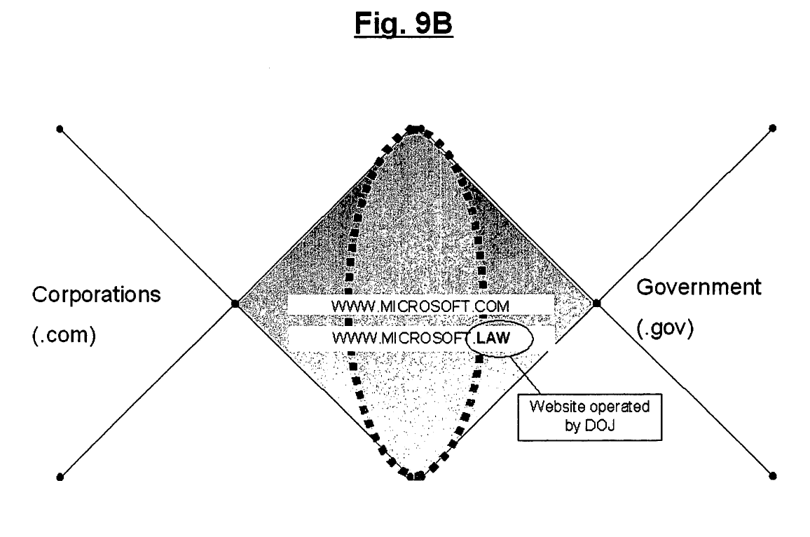

In the example above, the same EIN-bound company is associated differently within two different federal agencies (FIGS. 4A-J). In the brackets [*] are names of XML elements that will eventually reside on the DoJ's and EPA's Entity Domain Servers (EDS), respectively, however, for the purposes of internal agency qualification, these elements will be named in USML more ambiguously than XML and less ambiguously as the same elements will be named in the EINUSML-DB on the ARS, where inter-agency elements may be securely exchanged.

The process of implementation of the invention may be phased initially by providing each new TLD agency or organization with a list of pre-qualified elements which they then can determine whether or not to populate. An example of such an element with an XML attribute within a domain such as www.plumbtechnologiesinc.law would be <Region st=Ohio></Region>. In this specific example, the Region element will later provide a means for UD-DNS implementation on the state level (Ohio).

All of these elements that are qualified are encrypted in a global encryption file, and decrypted with a global encryption key, the former parts of which may be distributed to each relevant agency, and may be embedded (less the key) in USML software on the ARS in order to manage the EINUSML-DB.

It is preferred that while all of the aforementioned embodiment is taking place, a request is made to replicate and modify the XML Schema residing with the World Wide Web Consortium at www.w3.org. Within this Schema, which defines all XML machine-readable specifications for processing of the prior art, a similar schema may be subtly modified and hosted in order to distinguish Internet traffic from the protected traffic residing with the Web Integrity service (WIS), such which is described in the embodiment of the invention.

Once the agencies have received their first specific pre-qualified dataset template and established their EQS to work on, they can begin to determine which elements will be qualified and subsequently submitted to the ARS.

Meanwhile, the ARS may be set up initially as a platform through which http requests are received and dataset components are sent. This method may be submitted to each EDS once successfully established on the ARS, which once available to businesses and consumers may serve primarily as a subscription/payment server, EQS notification server, EINUSML-DB requester, and an IP cyber-craft carrier (IPC3) [ref: DOD SBIR FY06.1 AF68-068].

The ARS payment system may be implemented with prior art currently being utilized by the Department of Treasury, and, while pricing mechanisms are determined, adequate portions of subsequent subscription dividends may be distributed back to agencies and/or directed funding channels. It is anticipated that the service alone will pay for the implementation and maintenance across each agency. It is also anticipated that through implementation of this service, job opportunities will emerge both within agencies and among inter-agency organizations, such as the within the WIS itself. Again, it is anticipated that these costs will be absorbed by the service's revenues alone.

The ARS-EQS qualified element exchange system (QEES) will be implemented by what is described within this embodiment as well as with prior art currently being developed by inter-agency organizations such as the Architecture & Infrastructure Committee (AIC) and its XML-WG and ICM-WG. It is preferred by the inventor that, outside of the inventor's company, government employees less contractors be active in the implementation of the ARS-EQS QEES. The reasoning for this preference is described in the next paragraph.

A vast array of contracting opportunity can emerge from implementation for those not only contracting within government and emergency preparedness sectors but also within the private, education, research, and development sectors. For example, an encrypted representational portion of the EINUSML-DB structure may be embedded into a hardware-developer's processor chip, and subsequently implemented into hardware devices beyond the conventional PC, causing for essentially an innovative marketplace through which more patents may be obtained. Additionally, it is anticipated that search companies such as Google and Microsoft will as well find ways to integrate the invention with their own products & services, and therefore, as addressed in the Background section of this application, the focus for successful execution is in delineating between policy-making entities (agencies) first and money-making entities (ISPs) next.

It is preferred that Internet Service Providers (ISPs) may be solicited with regard to this invention in order to qualify prior art methods of Internet Protocol addressing and frame-working, although because much of the web integrity service is based upon the framework of American government, this is not necessarily a limiting preference. Such a protocol predicates the relatively primitive approach to IP addressing.

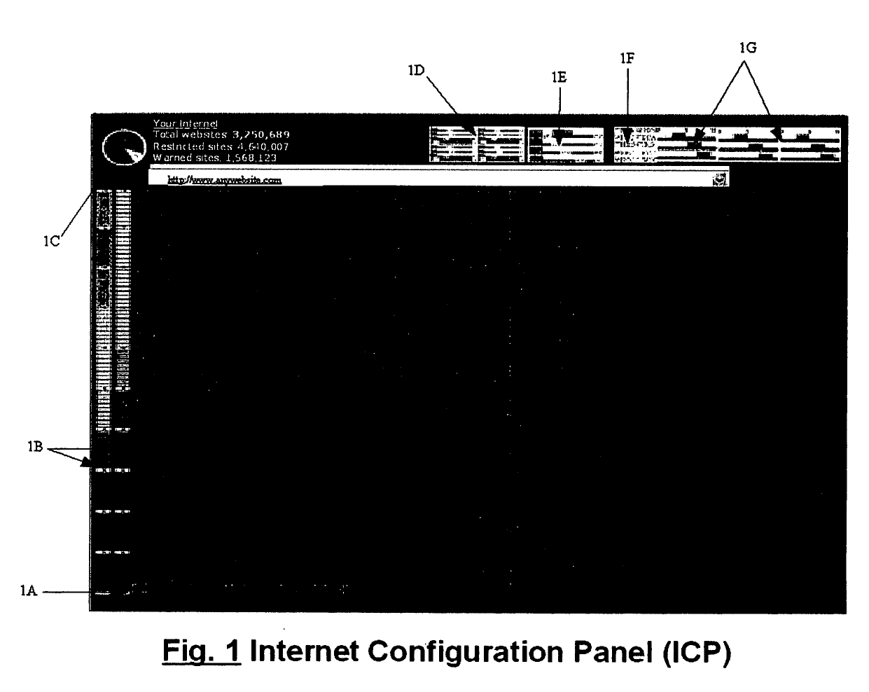

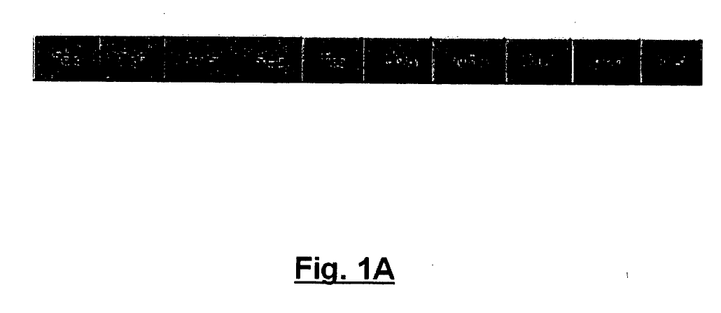

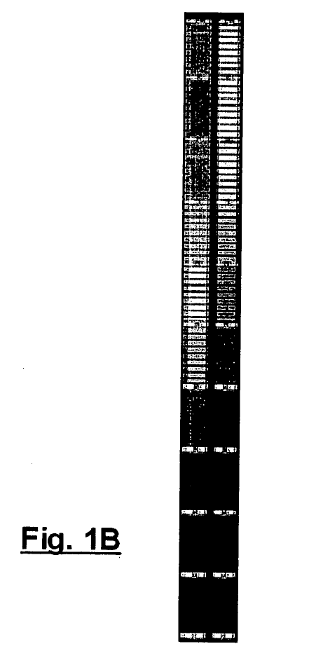

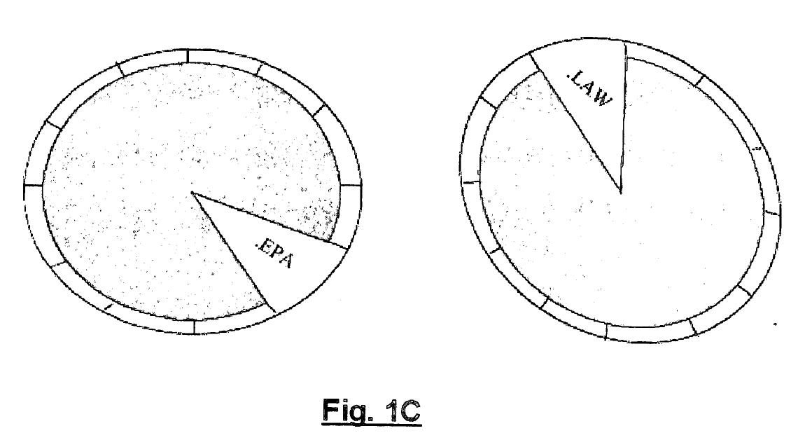

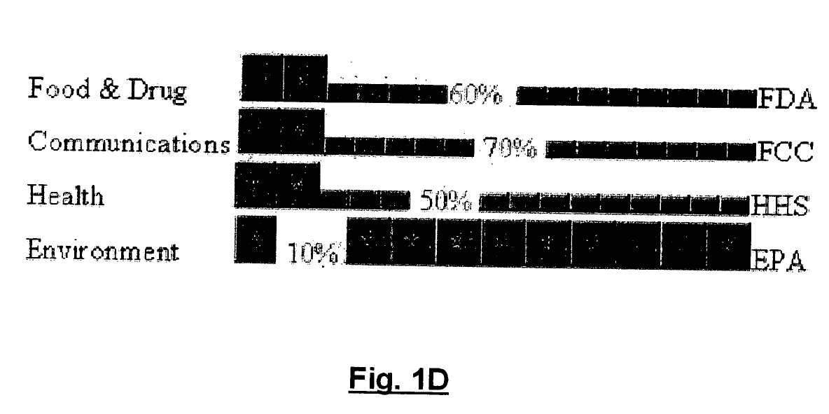

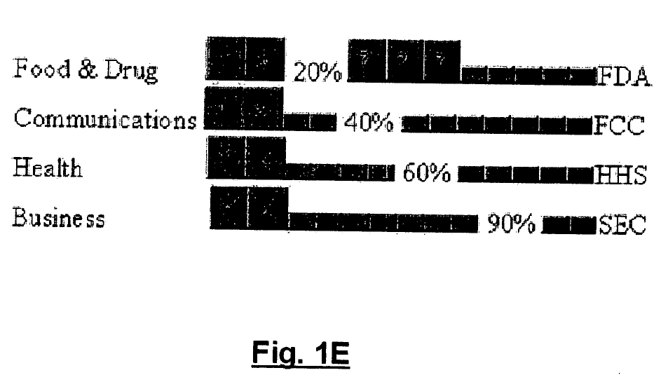

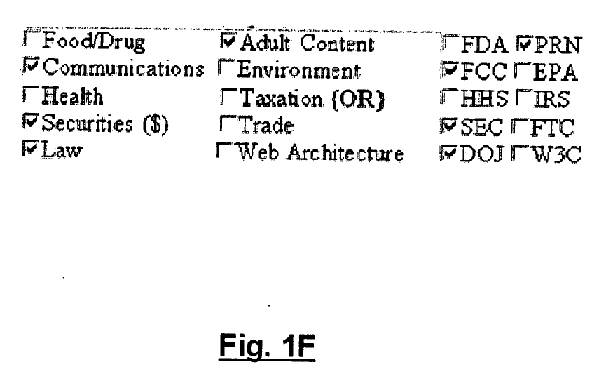

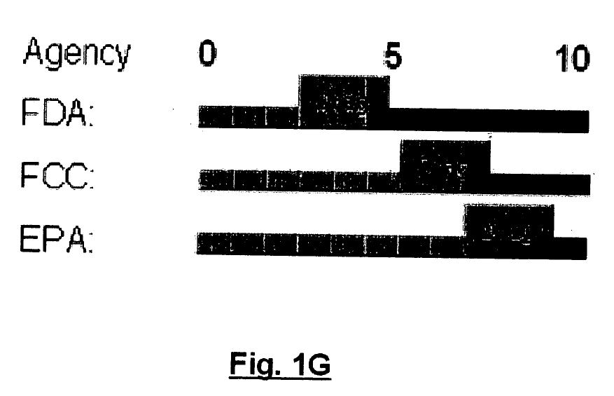

When a user client sends an http request to a DNS for IP resolution, a similar but unique request will be simultaneously sent to the ARS in order to incite the user's ICP (FIG. 1), which in turn will send requests to any and/or all of the agencies' EDS (FIG. 2). When the http request is successful, the web page will be returned but, if directed by the ARS, or any of the EDS data, the web page will be blocked, re-directed to one of the selected EDS, identified by visual ICP-embedded displays (FIGS. 1-1G), or reported to the ARS.

This is the dynamic nature of the UD-DNS system: the demand for web page views will require ISPs and their hosted website organizations to seek registry and subscription with the WIS, and in doing so, the plurality of such an http request will be more tightly woven, freeing up Internet traffic, and increasing the degree of information assurance as the user calibrates traversal(s).

The IPC3 is a service that may be utilized for security purposes by Defense. In modifying the ICP to meet this need, the scenario of perceiving a “cyber craft” creating itself on the Internet and then terminating itself when necessary is what can be achieved through the binding of IP addresses to relevant sets of data as aggregated within the UD-DNS system. Http-IP addressing paths from user to DNS to DNS grove mapped separate from Registry Identifier Number (RIN) requests to ARS & EDS will begin to draw an initial overlay of not only geo-spatial integrity, but also content-quality integrity, user-service integrity, and RF spectral terrain integrity. Defense may shape these overlays into maps combined with dataset attributes and semantic representations for a cyber-craft mechanism to traverse, or Defense may inversely cause these overlays to “vanish” upon command.

It is preferred that an appropriate time-line be established to qualify, for each new TLD, a small set of general elements in relation to current data that agencies have obtained and referenced by company classification (bound to http classification as described above). It may be preferential to include placeholder elements in each agency for information each agency wishes the subscriber to include during the initial registration process. This may be perceived as a competitive incentive for agencies as well as companies to take advantage of the invention, but in keeping the element dataset templates general in the first phase of implementation—just as the prior art root design has been kept simple for more than a decade—is important to the inventor. Specifically, the inventor has an encrypted list of over 200 elements suggested for agencies described herein: roughly 20 elements shape each agency dataset (FIGS. 4A-J). This is preferred but does not limit the possibilities.

The EDS may be set up with each agency following completion of each agency's first elemental dataset qualification to the ARS. The EDS will receive a transformed, Internet-ready, EIN-defined dataset grove from the agency's EQS—where the elements were pre-qualified and qualified—and bind the dataset to the server. Utilizing best practices and prior art of the DNS system, the EDS will be prepared for entry onto the Internet. It is essential that access to each EDS, such as www.whowhat.law, be made available (FIGS. 4A-J) only to those registered with and subscribing to the WIS. It is preferred that the registry process be phased by market sectors according to SIC/NAICS classification, beginning with government agencies/companies, in order to ensure smooth implementation of the UD-DNS system (FIG. 2). Regardless of the order of subscription opportunity, it is preferred that each agency determine the most efficient means to populate each of their datasets for the abundance of websites currently on the Internet, although this process will be significantly eased by an adequate demand for access to the registry service. Agencies may therefore choose to request information sets from companies when they are registering for the service, thereby providing companies with incentive to subscribe at a discounted rate.

Once the ARS and the per-agency EQS and EDS servers are up and running, the focus of implementation turns to the user-client and ICP (FIG. 1). Participating agencies may work with the WIS to improve functionality of their own ICPs which they will be able to test at this point of implementation. The commercial ICP will emerge from the ARS and its interactions with the EDS & EQS system, while agency-specific ICPs may benefit from further research & exploration of the product, as well as a more requirement-intensive “ICP Expert” version of the product. Versions of or sole components of the commercial ICP may appear lucrative to the current browser market. The visual overlays component of the WIS may be lucrative to current GPS market leaders. The information assurance features of the UD-DNS may be lucrative to personal computer—both desktop and hand-held—companies who have portioned billions of annual dollars to Internet security alone.

The initial ICP itself will be developed by delegating work to specific engineers, administrators, and developers, all of whom will have compartmentalized tasks in establishing the GUI elements, link libraries, service packages, algorithmic formulas, cyber-craft utilities, and security measures for each. This team will have individual focuses on strategy, execution, and/or calibration while working in conjunction with trusted W3C, ICANN, Grove USA and other community-specific members.

It is preferred but not limiting that as much of this embodiment be striven for prior to filing for a PCT with WIPO in April 2006. The further ahead the United States can get with regard to this service—which is anticipated to be deployed architecturally to foreign governments and the international stage—the better off our workforce will be in facing the challenges of the global economy. It is preferred that, if perceived as a deterrent for war both current and future, such as that it may be deployed to newly-established governing systems, the invention and claims herein be prosecuted as efficiently and effectively as possible.

In fact, whereas there are a small handful of new externally managed TLDs listed in stride with this invention, it is anticipated that, once marketed and sold overseas, and implemented, their could be as many as 200-300 UD-DNS systems in existence, without mentioning vertical integration of state- and city-level versions as well as an international version. Furthermore, it is anticipated that this invention could render the http method of browsing either obsolete or out-of-view, as ICP technologies may sense companies and websites by their names alone, combined with the precedent the user sets on such entities. No more www . . . com? It is anticipated!

In summary, the United States government is already working on inter-agency methods of XML transmission of information. Therefore, implementing this invention with what has been gathered via the prior art and necessity will require many people although the work is significantly less as agencies like EPA and DoJ already have established XML dataset transmission systems and working schemas, with the breadth of the entire agency-level community moving in stride.

With the security problems facing the current architecture of the Internet, the UD-DNS system could offer public and private sectors a powerful new Peripheral Learning tool in which to educate, train, protect, and maintain along the hyper growth of the semantic web: whereas government conventionally moves much slower than private business, a web integrity service may help calibrate the differing velocities by which we all conduct ourselves and our business.

What is claimed is:

1. A computer- and human-implemented method for processing taxonomic extensions via the world wide web to implement an integrity-rich intelligence apparatus, the method comprising:
for each second level domain with current top level domains (TLDs) on the Internet, a set of specific, parallel and externally-managed TLD name extensions which semantically derive relevant information for the user.

2. The method of claim 1 wherein the web page of any root http address (Universal Resource Locator/Identifier (URL/URI)) may be identified as having TLDs in existence separate from the owners of the original http address, using http to parse the common TLD with a new TLD, thereby revealing applicable content in the context of the second-level domain, whereas the TLD likewise reveals the authenticating source of such content.

3. The method of claim 2 wherein an authentication registry server (ARS) is maintained, comprising:
A global encrypted key comprising:
a structure of dataset templates representative of each new externally-managed TLD,
An entity identification name (EIN) binding the root http address with the entity owner;
A processing instruction comprising a system of graphical user interfaces (GUIs) binding an Internet user with the ARS.

4. The method of claim 3 wherein each externally-managed TLD is accessible via communication per a unique entity domain server (EDS), that has writable datasets housed per its signifying entity qualification server (EQS), the latter comprising:
A pre-qualifed-qualified database (P-QQ-DB) listing a key for all registry identifier numbers (RINs) bound to EINs, wherein an EIN comprises an RIN bound to an EQS number.

5. The method of claim 4 wherein each EIN is bound to a sub-component dataset template imported from the host of the ARS.

6. The method of claim 5 wherein each sub-component dataset template has either configurable or non-configurable instructions, where each instruction comprises either an extensible service or not.

7. The method of claim 6 wherein an externally-managed EQS comprises a list of sub-component dataset templates, EINs, and
time-stamped pre-qualification datasets,
time-stamped qualified datasets, and
export instructions to both its EDS and the ARS.

8. The method of claim 7 comprising access levels determined within each time-stamped pre-qualification dataset representing new externally-managed TLDs.

9. The method of claim 1 wherein each newly extended and externally-managed TLD is representative of relevant aspects of governance based on precedence and public service, comprising prior Internet-based languages in which policy-making did not have precedent.

10. The method of claim 3 & 8 wherein the processing instruction comprises:
An Access Bar; a GUI by which the user visually and audibly identifies which generic TLD-identifiable websites are externally managed by new TLDs, (FIG. 1A)
A Parallel Management Rank Display; a GUI by which a user visually and audibly identifies which generic TLD-identifiable websites are ranked within datasets of new externally-managed TLDs, (FIG. 1E)
A Web Precision Dial (FIG. 1C); a GUI by which a user may:
Restrict websites comprised of generic TLDs and navigates the Internet by viewing information available via one selected new TLD setting, or
When viewing visual overlays of aggregated data relevant to browsed websites, adjust the overlay as to only display the information relevant to the selected new TLD,
A Precedence Tuner; a GUI by which a user ranks preference of each new externally-managed TLD, (FIG. 1G)
A Utopia Tuner Display; a GUI by which a user identifies visually and audibly which generic TLD-identifiable websites are ranked according to datasets ranked by externally-managed representatives of new TLDs proximate to the user's ranks of importance as identified by the settings of the Precedence Tuner, (FIGS. 1B, 1D)
A Resonance Tuner; a GUI by which the user can toggle up or down and effect the amount of data processed in each of the aforementioned GUI instructions, the depth of which may range from website-browsed to website-host-browsed to website-with-embedded-links-browsed to website-community-browsed,
A Multi-User Adjustment Menu (MUAM); by which a user may:
Name and save configuration settings comprising all the GUI methods in this claim,
Load saved configuration settings from another user or merge saved configuration settings from another user with his/her own, and
Name and save merged configuration settings, and
An Integrity Playback Options Menu (IPOM); by which a user may:
Set a Log File to cache configured datasets from certain websites traversed over time, and
View an animated sequence of configuration settings transformations, if any, regarding certain websites as saved in the Log File.

11. The method of claim 10 wherein a Restrictions Menu is implemented, wherein a list identifying each new externally-managed TLD is user-selected that instructs the user's browser to only access websites which display datasets from the selected externally-managed TLDs on the list. (FIG. 1F)

12. The method of claim 1 wherein the operators of the externally-managed multiple web sites are public servants, and wherein the analyzing of the web site datasets for the websites is performed as a service for the protection of the public integrity, comprising:
Users of the method of claim 1 allotted access by the ARS,
Public servants who are users of the method of claim 1 allotted access by the representatives of the new externally-managed TLDs, and
Public servants who are users of the method of claim 1 who are developers of the service as described in claims 1-11.

13. The method of claim 3 wherein Internet Protocol (IP) addresses are bound with RINs, the method comprising:
A Registered Identifier Number (RIN),
A Registrar Name through which the website owner is registered.
A Device List, comprising:
a number of devices identified as belonging to the RIN,
IP address(es) assigned to each device,
The Type and Model Number of each device, and
An access level as set by the device registrant,

14. The method of claim 13 wherein the content set is a router,

15. The method of claim 13 wherein the content set is a hand-held device, the device comprising:
A GUI display essentially comprised of the method of claim 10, comprising a selector-switch to allow the user to monitor the externally-managed new TLD datasets of the website that is traversed by a third party whose RIN is the same as that of the device owner,

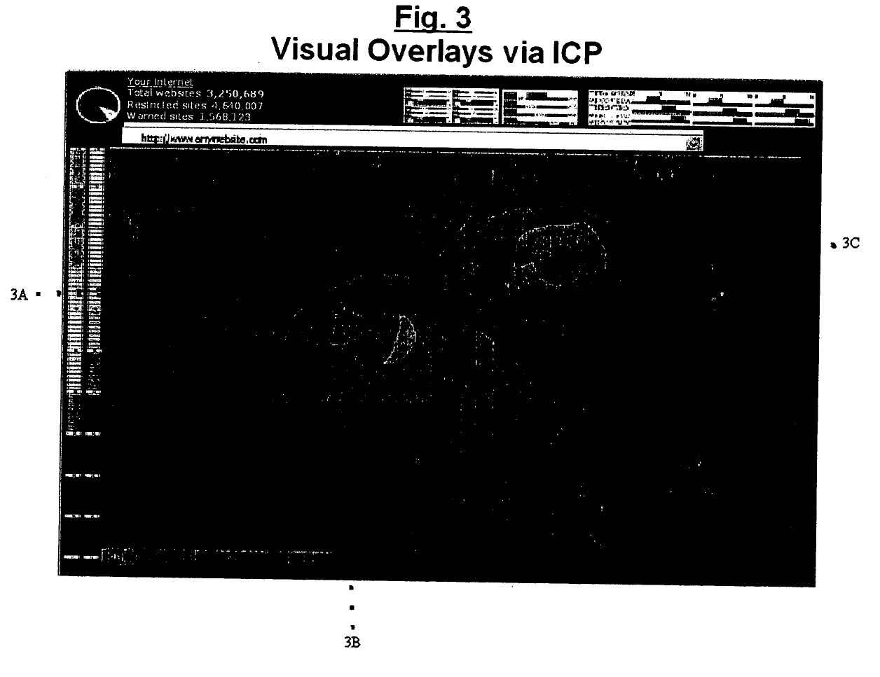

16. The method of claim 13 wherein the content set is a visual mapping overlay display system (FIG. 3), the method comprising:
Identifiable color-codes representative of each new externally-managed TLD and its applicable datasets, wherein the geo-spatial positioning of all devices relevant to the user's browsed webpage's Second Level Domain (SLD) is defined via an overlay of a map (FIG. 3),
A color-intensity key in which externally-managed TLD representatives rank components of datasets as bound to the SLD the user is browsing,
A color-intensity key in which users modify according to interest of new externally-managed TLDs,
A color-intensity key in which users rank by importance specifically accessed components of the selected new externally-managed TLD(s),
A flashpoint or flagpoint (FIG. 3A) and beep (audible) that identify coordinates for user of web page being browsed of warnings as identified by new externally-managed TLDs and as identified geo-spatially by overlay,
A flashpoint or flagpoint (FIG. 3A) and beep (audible) that identify coordinates for user of web page being browsed of warnings as identified by the user according to user's level of interest in datasets provided by new externally-managed TLDs.

17. The method of claims 1-16, wherein the components are essentially comprised of an Internet Configuration Panel (ICP). (FIG. 1)

18. The method of claim 3, wherein the global encrypted key is best kept in the interest of national security and international security.

19. The method of claim 1, wherein the new TLDs comprise:
“.epa”, represented by the Environmental Protection Agency,
“.law”, represented by the Department of Justice,
“.fcc”, represented by the Federal Communications Commission,
“.ftc”, represented by the Federal Trade Commission,
“.sec”, represented by the Securities & Exchange Commission,
“.hhs”, represented by the Department of Health & Human Services,
“.fda”, represented by the Food & Drug Administration,
“.prn”, represented by the Federal Communications Commission,
“.fdic”, represented by the Federal Deposit Insurance Corporation,
“.irs”, represented by the Department of Treasury,
“.dos”, represented by the State Department,
“.nasa”, represented by NASA,
“.noaa”, represented by NOAA,
“.fema”, represented by FEMA,
“.dag”, represented by the Department of Agriculture,
“.dol”, represented by the Department of Labor, and
“.dhs”, represented by the Department of Homeland Security,

20. The method of claim 1, wherein the new TLDs comprise:
“.un”, represented by the United Nations,
“.who”, represented by the World Health Organization,
“.wto”, represented by the World Trade Organization,
“.w3c”, represented by the World Wide Web Consortium,
“.icann”, represented by the Internet Corp. for Assigning Names & Numbers,
“.med”, represented by the method of claim 16,

21. The method of claim 1, wherein a first level domain (eg: “www.”) may be representative of a new TLD's subsidiary organization or agency (eg: “cdc.whowhat.hhs” meaning the Center for Disease Control, an agency within the Department of Health & Human Services),

22. The method of claim 1, wherein a TLD comprises “.tax”, represented by the Department of Commerce, wherein a dataset bound to that extension represents an aggregated taxonomy as filed with and determined by the DoC, wherein the taxonomy comprises:
the business entity,
the business organizational structure relevant to its vendors,
subsidiaries, representatives, and affiliates who have relevant correlation to each of the new externally-managed TLDs, and
the subsequent relationships extending thereof,

23. The method of claims 1 & 16, wherein an embedded link “medium” in an email message displays claimed information processes conducted via geo- and cyber-spatial mapping describing the path of the email transmittal relevant to the business entities, such as the sites' hosts and ISPs associated with the transmittal, when clicked,

24. The method of claims 1-23, wherein a web integrity service (WIS) is created,

25. The method of claim 24, comprised of an American Web Calibration Commission (AWCC), the method essentially comprised of:
a group of 9 representatives comprised of 3 from each political party (the third representative of the electorate's Independents or Libertarians),
a staff to support the representatives and to protect the WIS,
a team of liaisons with the inventor of the WIS, and
the developers of such.

26. The method of claim 3 wherein the processing instruction is encoded via USML (United States Markup Language), comprising:
a definition list defining all USML elements, attributes, functions, and processing instructions in human- and machine-readable XML,
XSL templates ordering USML elements specific to each existing EIN,
a database of EINs bound to populated USML elements (EINUSML-DB),
a client-side link library package comprising:
a graphics file folder
a list of GUI element names (FIGS. 1-1G), attributes, and paths
a gateway file instructing the ARS to connect to the client, comprising:
options for connection frequency (per page browsed, per domain traversed, or per connection speed [incremental refresh])
client access rights
privilege-session rights, comprising
Registry ID Number (RIDN)
a RIDN port listing, comprising instructions for a client-side port to be utilized for the session,
Username,
Password, and
EIN List,
USML-encoded “morphables”, files written according to user-definition and then used to call and shape data from new TLD's EDS (FIG. 2) into user's browser experience (FIGS. 1, 3),
code linking a GUI element whose attributes call datasets from morphables and formats them via templates,
an autonomous systems aggregator file, comprising:
mathematical formulas which function to formulate enumerations based on rank-associated data within the client's morphables,
an autonomous systems viewer bar 1 (asvb1) (FIG. 1B) list of attributes associated with the formulaic data,
a processing instruction which imports mathematical data based on parallel management rank (pmr) display settings (FIG. 1E) then relays the results into the asvb1,
mathematical formulas which function to send enumerations of pmr display settings to the utopia tuner display (FIG. 1D) and store same enumerations for compiling of attributes to display within an autonomous systems viewer bar 2 (asvb2) (FIG. 1B) according to the content written in the asvb2 file,
an asvb2 file, per point-and-click menu settings on user's ICP (FIG. 1), comprising write, save, and compile instructions according to the degree by which the user sets them (eg: user may wish to view pmr data, compiled rather than real-time pmr display data, in the asv2, or aggregate asv1 data over a traversal of website viewings during one session, one day, one month, an individual's user experience, or via visits to specific areas on the Internet (such as by adjustment of the web precision dial (FIG. 1C) or restrictions menu (FIG. 1F) on the user's ICP)),
a privileges-session file which sends registrant-exported datasets to a registry update notification file,
an EQS service package, the sum of which will be managed by each new TLD agency or organization, comprising:
a secure ARS-EQS qualified element exchange system (QEES), the EQS comprising:
a pre-qualified-qualified database (P-QQ-DB) of files comprising two sets of display data ordered by EIN groves, each EIN grove comprising access levels and pmr data, comprising:
access levels based on the prior art of rights management methods, and
a numerical dataset which enumerates datasets by rank of
standing determined by the entity domain representatives,
a registry update notification file, comprising instructions for processing unqualified P-QQ-DB elements imported from the ARS, pre-qualified, then qualified, transformed, exported as read-only to the EDS and inserted into the EDSML-DB, and a qualification file, comprising instructions for qualifying pre-qualified EQS data and exporting it to the ARS,
an enhanced EQS ICP, comprising all elements of the ICP plus any extensible configurations determined appropriate by the new TLD agency or organization, and
a gatekeeper link library, comprising files for the EQS operator to monitor incoming registrant info and outgoing ARS info,
an EDS service package, comprising:
a privilege-sessions rights key list, comprising RIDN settings for public access to the EDS,
the EDSML-DB, comprising datasets written from the EQS, and
a display-service file, comprising component processing utilities for incoming morphable-file requesters,
an ARS package, comprising:
a registry execution file, comprising instructions for receiving and inserting qualified EQS data into the EINUSML-DB,
the EINUSML-DB file, supporting all qualified EQS data,
a subscriber file, comprising all subscriber information associated by RIN, EIN, or both,
a payment system, comprising methods for the subscriber (user) to traverse the UD-DNS system,
a user-support interface, comprising instructions for the ARS operators to notify and send updates of ICP software to registered and subscribing users, and
an EQS autonomous systems aggregator file, comprising:
mathematical formulas which function to formulate enumerations out of the EINUSML-DB based on rank-associated data within a set of EQS imports bound by EIN, and
mathematical formulas which function to send enumerations of EQS imports to registered subscribers and store same enumerations within an autonomous systems database (as-db).

27. The method of claims 1-26, wherein the system is a Unified-Dynamic Domain Name Server (UD-DNS) system. (FIG. 2)
